(19) United States
(12) Patent Application Publication
(10) Pub. No.: US 2012/0278249 A1
(43) Pub. Date: Nov. 1, 2012

(54) Generating an Identity Theft Score

(75) Inventors: Chanderpreet Singh Duggal, (US); William R. Dyer, (US); Richa J. Goyal, (US); David E. Kroner, (US); Deepak Maheshwwari, (US); Eileen P. McMahan, (US); Rachel E. Moore, (US); Paul M. O'Malley, Randolph, NJ (US); Pradeep Vallanur Ramesh, Scottsdale, AZ (US); William O. Rauschenbach, (US); Swati Vijay, (US)

(73) Assignee: American Express Travel Related Services Company, Inc., New York, NY (US)

(21) Appl. No.: 13/098,245

(22) Filed: Apr. 29, 2011

(51) Int. Cl. G06Q 99/00

(52) U.S. Cl. 705/325

(57) ABSTRACT

A system for generating an identity theft score is disclosed. The system may identify consumers who have experienced identity theft during a historical time period, generate an identity theft risk model based upon the plurality of consumers who have experienced identity theft, and generate an identity theft score for an individual consumer based upon the identity theft risk model and data associated with the individual consumer. The identity theft risk model may comprise a regression model, and the identity theft score may represent a probability that the individual consumer will experience identity theft during a future time period.

### BACKGROUND

1. Field of the Invention

The present disclosure generally relates to identity theft protection.

2. Related Art

In accordance with the Federal Trade Commission (“FTC”) definition, in general, identity theft occurs when a person uses another person's personally identifiable information (“PII”) to commit a fraud. PII may include any data that may be used to uniquely identify, locate, and/or contact an individual person. For example, PII may include a person's social security number, IP address, vehicle registration plate number, driver's license number, biometric data, transaction account numbers/codes, birthday, birthplace, passport data, and the like. Further, according to the FTC, identity theft may be classified in three broad categories. These are: (1) Existing card account identity theft; (2) Existing non-card account identity theft; and (3) New account identity theft. Existing card account identity theft is fraud committed using an existing transaction account. Existing non-card account identity theft is fraud committed using checking and savings accounts, existing loans, insurance, telephone and utilities accounts, and the like. New account identity theft is fraud committed using a person's PII to obtain a new account, loan, etc.

According to a recent Javelin Identity Fraud Survey Report, 8.1 million people were victims of identity theft and identity fraud during the course of a single year (2011 Javelin Strategy & Research). Furthermore, the Department of Justice (“DOJ”) reports that identity theft related crimes cost victims $5 billion in out-of-pocket expenses, while costs to financial institutions approached $48 billion. See U.S. Department of Justice website, Justice Resource Update, Resources for Fighting Identity Theft, Regina B. Schofield, Spring 2006.

Thus, identity theft and identity theft related crimes often have staggering economic consequences. Indeed, such crimes not only cause banks and credit card companies to experience tremendous financial losses, they often have devastating impacts on the individuals whose identities are “stolen.” Indeed, a 2004 press release by the Identity Theft Resource Center (“ITRC”) found that half of the victims surveyed spent more than 100 hours repairing the damage done by identity thieves. Moreover, the mean number of hours spent repairing damage caused by identity theft totaled approximately 330 hours. See Identity Theft Resource Center Surveys and Studies, Press Release: Identity Theft: The Aftermath 2004, May 7, 2007. The same report by the ITRC noted significant emotional impacts resulting from identity theft. Specifically, 9% of the surveyed victims in 2003 and 16% of surveyed victims in 2004 reported that their personal relationships were either “on the rocks” or in fact ended as a result of identity theft. Id.

Identity theft has serious financial and personal impacts, both individually and more broadly, on the businesses—like credit card companies—that must undertake to assist customers whose identities have been stolen. Although the federal government has recognized that identity theft poses a serious threat and prosecutes such crimes, nevertheless, the occurrence of these crimes typically continues rather unabated. Accordingly, what is needed is an improved mechanism for deterring identity theft before it happens. Specifically, what is lacking is a robust tool which provides a consumer with an advanced warning that he may be at risk of identity theft. With such a tool, the emotional and financial impacts caused by identity theft may be mitigated before they occur.

### SUMMARY

The present disclosure includes systems, methods, and articles for generating an identity theft score. The system may identify consumers who have experienced identity theft during a historical time period, generate an identity theft risk model based upon the consumers who have experienced identity theft, and generate an identity theft score for an individual consumer based upon the identity theft risk model and data associated with the individual consumer. The identity theft risk model may comprise a regression model and the identity theft score may represent a probability that the individual consumer will experience identity theft during a future time period.

Consumers who have experienced identity theft may comprise, for example, consumers who have experienced transaction fraud during the historical time period, consumers who have experienced application fraud during the historical time period, and consumers who have experienced maintenance fraud during the historical time period. An identity theft risk model may be further based upon consumers who have not experienced identity theft during the historical time period. In addition, an identity theft risk model may comprise a segmented regression model and each of the segments comprising a segmented regression model may be associated with an identity theft score. An identity theft score may be adjusted based upon a business rule (or rules). A business rule may comprise data that contradicts and/or confirms the accuracy of an identity theft score.

### BRIEF DESCRIPTION OF THE DRAWINGS

The features and advantages of the present disclosure will become more apparent from the detailed description set forth below when taken in conjunction with the drawings. The left-most digit of a reference number identifies the drawing in which the reference number first appears.

FIG. 1 shows an exemplary system diagram in accordance with an embodiment.

FIG. 2 shows a flowchart depicting an exemplary process for generating an identity theft risk model.

FIG. 3 shows a segmented identity theft score model based upon a single independent variable.

FIG. 4 shows a flowchart depicting an exemplary process for generating an identity theft score.

FIG. 5 shows an exemplary identity theft score user interface and web-page.

FIG. 6 shows an exemplary table illustrating a range of identity theft scores and descriptions thereof.

### DETAILED DESCRIPTION

The detailed description of exemplary embodiments herein makes reference to the accompanying drawings, which show the exemplary embodiments by way of illustration and their best mode. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Phrases and terms similar to “financial institution,” “transaction account issuer,” and “payment processor” may include any person, entity, software and/or hardware that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business”, “merchant”, “supplier” or “seller” may be used interchangeably with each other and shall mean any person, entity, distributor system, software and/or hardware that is a provider, broker and/or any other entity in the distribution chain of goods or services and/or that receives payment or other consideration. For example, a merchant may be a grocery store, a retail store, a travel agency, a service provider, an on-line merchant or the like. For example, a supplier may request payment for goods sold to a buyer who holds an account with a transaction account issuer.

The terms “payment vehicle,” “financial transaction instrument,” “transaction instrument,” or “transaction account product” may be used interchangeably throughout to refer to a financial instrument. As used herein, an account code may or may not be associated with a physical financial instrument.

Phrases and terms similar to a “buyer,” “participant”, “consumer,” and “user” may include any person, entity, software and/or hardware that receives items in exchange for consideration (e.g. financial payment). For example, a buyer may purchase, lease, rent, barter or otherwise obtain items from a supplier and pay the supplier using a transaction account.

Phrases and terms similar to an “item” may include any good, service, information, experience, reward, points, coupons, credits, monetary equivalent, anything of value, something of minimal or no value, etc.

Phrases or terms similar to a “processor” (such as a payment processor) may include a company (e.g., a third party) appointed (e.g., by a merchant) to handle transactions for merchant banks. Processors may be broken down into two types: front-end and back-end. Front-end processors have connections to various transaction accounts and supply authorization and settlement services to the merchant banks' merchants. Back-end processors accept settlements from front-end processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction.

Phrases or terms similar to a “payment gateway” or “gateway” may include an application service provider that authorizes payments for e-businesses, online retailers, and/or traditional brick and mortar merchants. A payment gateway may protect transaction account details by encrypting sensitive information, such as transaction account numbers, to ensure that information passes securely between the customer and the merchant and also between merchant and payment processor.

As used herein, “transmit” may include sending electronic data from one system component to another over a network connection. Additionally, as used herein, “data” may include encompassing information such as commands, queries, files, data for storage, and the like in digital or any other form.

As used herein, “issue a debit”, “debit” or “debiting” refers to either causing the debiting of a stored value or prepaid card-type financial account, or causing the charging of a credit or charge card-type financial account, as applicable.

Phrases or terms similar to “transaction account” may include any account that may be used to facilitate a financial transaction. A “transaction account” as used herein refers to an account associated with an open account or a closed account system (as described herein). The transaction account may exist in a physical or non-physical embodiment. For example, a transaction account may be distributed in non-physical embodiments such as an account number, frequent-flyer account, and telephone calling account or the like. Furthermore, a physical embodiment of a transaction account may be distributed as a financial instrument.

In general, transaction accounts may be used for transactions between the user and merchant through any suitable communication means, such as, for example, a telephone network, intranet, the global, public Internet, a point of interaction device (e.g., a point of sale (POS) device, personal digital assistant (PDA), mobile telephone, kiosk, etc.), online communications, off-line communications, wireless communications, and/or the like.

An “account”, “account code”, or “account number”, as used herein, may include any device, code, number, letter, symbol, digital certificate, smart chip, digital signal, analog signal, biometric or other identifier/indicia suitably configured to allow the consumer to access, interact with or communicate with the system (e.g., one or more of an authorization/access code, personal identification number (PIN), Internet code, other identification code, and/or the like). The account number may optionally be located on or associated with a rewards card, charge card, credit card, debit card, prepaid card, telephone card, embossed card, smart card, magnetic stripe card, bar code card, transponder, radio frequency card or an associated account. The system may include or interface with any of the foregoing cards or devices, or a transponder and RFID reader in RF communication with the transponder (which may include a fob). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples can include watches, Internet enabled kitchen appliances, restaurant tables embedded with RF readers, wallets or purses with imbedded transponders, etc.

The account code may be distributed and stored in any form of plastic, electronic, magnetic, radio frequency, wireless, audio and/or optical device capable of transmitting or downloading data from itself to a second device. A customer account code may be, for example, a sixteen-digit transaction account code, although each transaction account provider has its own numbering system, such as the fifteen-digit numbering system used by American Express. Each company's transaction account codes comply with that company's standardized format such that the company using a fifteen-digit format will generally use three-spaced sets of numbers, as represented by the number “0000 000000 00000”. The first five to seven digits are reserved for processing purposes and identify the issuing bank, card type, etc. In this example, the last (fifteenth) digit is used as a sum check for the fifteen digit number. The intermediary eight-to-eleven digits are used to uniquely identify the customer. A merchant account code may be, for example, any number or alpha-numeric characters that identify a particular merchant for purposes of card acceptance, account reconciliation, reporting, or the like.

It should be noted that the transfer of information in accordance with the present disclosure, may be completed in a format recognizable by a merchant system or account issuer. In that regard, by way of example, the information may be transmitted from an RFID device to an RFID reader or from the RFID reader to the merchant system in magnetic stripe or multi-track magnetic stripe format.

In one exemplary embodiment, a system, method and/or computer program product for generating an identity theft score is disclosed. The identity theft score may be based on a variety of internal and/or external data (e.g., obtained from outside sources) and may be used with a variety of protection tools to protect an individual from identity theft and fraud. For example, an identity theft score may help, in combination with system 100, to protect an individual from existing card account identity theft, existing non-card account identity theft, new account identity theft, as well as, more broadly, theft of a person's PII, as described above.

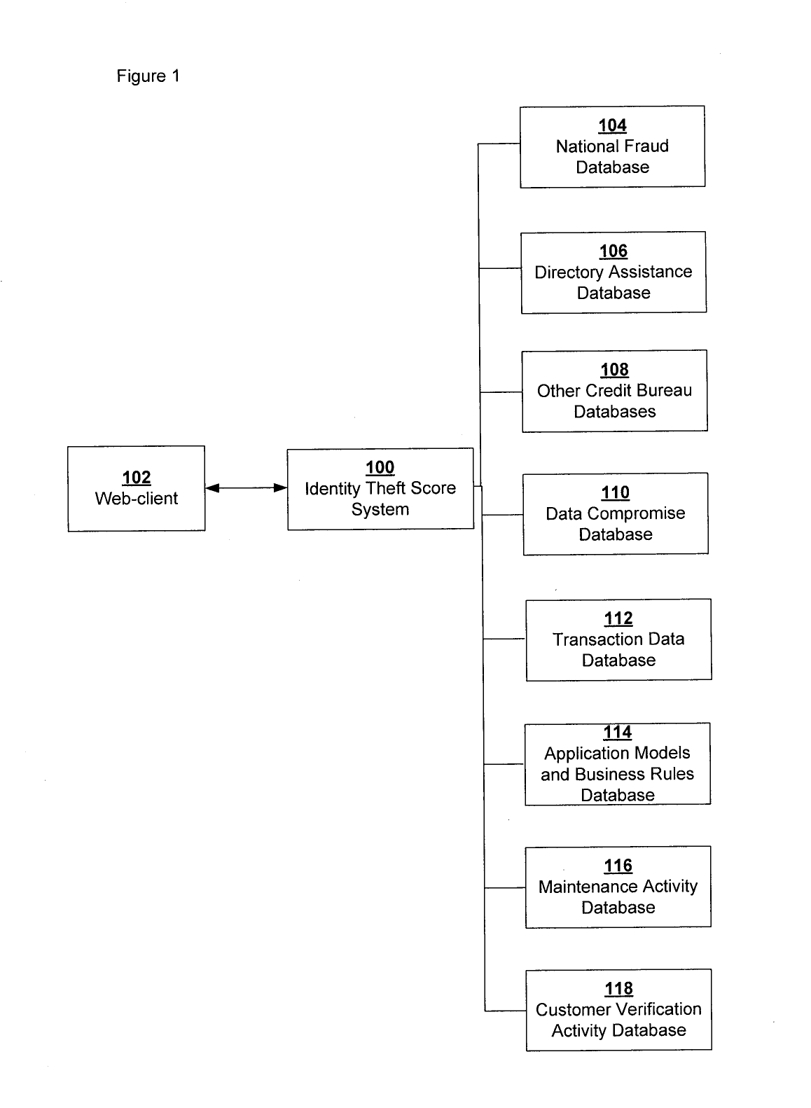

Referring to FIG. 1, an exemplary system 100 for generating an identity theft score is disclosed. System 100 may be coupled, by way of a network 120, to a web-client 102 and a plurality of internal and/or external data sources. An internal data source may comprise a data source that is owned by or proprietary to an owner/developer of an identity theft risk model (e.g., American Express). Internal data sources may comprise data compromise database 110, a transaction data database 112, an application models and business rules database 114, a maintenance activity database 116, and/or a customer verification activity database 118. An external data source may comprise any data source that is not owned by or proprietary to an owner/developer of an identity theft risk model (e.g., American Express). External data sources may comprise a National Fraud Database 104, a Directory Assistance database 106, other credit bureau databases 108, a data compromise database 110, a transaction data database 112, an application models and business rules database 114, a maintenance activity database 116, and/or a customer verification activity database 118.

System 100 may comprise software and/or hardware suitably configured or configurable to receive and/or process data. Thus, system 100 may comprise a rack mountable server appliance running a suitable server operating system (e.g., IIS) and having database software (e.g., Oracle) installed thereon. System 100 may be configured or configurable to generate/solve/evaluate an identity theft risk model and/or identity theft score.

Web-client 102 may include any device (e.g., personal computer) which communicates via any network 120, for example such as those discussed herein. A web-client 102 may comprise a variety of browsing software or browser applications. Such browser applications comprise Internet browsing software installed within a computing unit or a system to conduct online transactions and/or communications. These computing units or systems may take the form of a computer or set of computers, although other types of computing units or systems may be used, including laptops, notebooks, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. A web-client 102 may run Microsoft Internet Explorer, Mozilla Firefox, Google Chrome, Apple Safari, or any other of the myriad software packages available for browsing the internet.

Web-client 102 may or may not be in direct contact with an application server (e.g., system 100). For example, web-client 102 may access the services of an application server through another server and/or hardware component, which may have a direct or indirect connection to an Internet server. For example, web-client 102 may communicate with an application server via a load balancer. In an exemplary embodiment, access is through a network or the Internet through a commercially-available web-browser software package.

As those skilled in the art will appreciate, a web-client 102 may include an operating system (e.g., Windows NT, 95/98/2000/CE/Mobile, OS2, UNIX, Linux, Solaris, MacOS, PalmOS, etc.) as well as various conventional support software and drivers typically associated with computers. A web client 102 may include any suitable personal computer, network computer, workstation, personal digital assistant, cellular phone, smart phone, minicomputer, mainframe and the like. A web-client 102 may implement security protocols such as Secure Sockets Layer (SSL) and Transport Layer Security (TLS). A web-client 102 may implement one or more application layer protocols, including, for example, http, https, ftp, and sftp.

Network 120 may comprise any electronic communications system or method which incorporates software and/or hardware components. Communication may be accomplished through any suitable communication channels, such as, for example, a telephone network, an extranet, an intranet, Internet, point of interaction device (point of sale device, personal digital assistant, smart phone, cellular phone (e.g., iPhone®, Palm Pilot®, Blackberry®), kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although network 120 may be described herein as being implemented with TCP/IP communications protocols, the network 120 may also be implemented using IPX, Appletalk, IP-6, NetBIOS, OSI, any tunneling protocol (e.g. IPsec, SSH), or any number of existing or future protocols. If the network 120 is in the nature of a public network, such as the Internet, it may be advantageous to presume the network 120 to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components described herein (e.g., system 100 and/or web-client 102, and/or external/internal data sources 104-118) may be independently, separately or collectively coupled to the network 120 via one or more data links including, for example, a connection to an Internet Service Provider (ISP) over a local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network 120 may be implemented variously. For example, network 120 may be implemented as an interactive television (ITV) network. The systems and methods disclosed herein contemplate the use, sale and/or distribution of any goods, services or information over any network having functionality similar to that described above with reference to network 120.

National Fraud Database 104 may comprise any hardware and/or software configured or configurable to receive data from one or more credit grantors. National Fraud Database 104 may contain information related to verified records or incidences of fraud. A variety of credit grantors (e.g., transaction account issuers) may share information by way of National Fraud Database 104.

Directory Assistance database 106 may comprise any hardware and/or software configured or configurable to verify the identity of a customer or consumer. Directory Assistance database 106 may comprise a database or list of consumer's personal identifying information. For example, Directory Assistance database 106 may comprise a database or list of consumer's phone numbers, previous and/or current addresses, ages, dates of birth, relatives, and the like.

Other credit bureau databases 108 may comprise any hardware and/or software associated with any of the credit bureaus in the United States or any other country. Other credit bureau databases 108 may provide data such as a number of inquiries by a creditor/transaction account issuer/lender, a number of lost and/or stolen trade lines reported by a bureau (or to a bureau by a consumer), and the like.

Data compromise database 110 may comprise any hardware and/or software configured or configurable to hold and/or process data that may be used to determine whether data associated with a consumer has been compromised. Thus, for example, data compromise database 110 may comprise data suggesting that the security and/or privacy of a consumer's personal data has been compromised by a system breach/failure, an action taken by the consumer, and the like. Data compromise database 110 may further comprise data gathered by one or more web-crawlers. The data gathered by a web-crawler may identify possible or confirmed transaction account data that is being traded on the internet or another public or private network.

Further, a web-crawler or other external source may gather internal data (i.e., data associated with a transaction account issuer such as American Express) as well as external data (i.e., data associated with a consumer that is not necessarily maintained by or known to, through its own systems, a transaction account issuer, such as American Express) for inclusion in data compromise database 110. Examples of data that a web-crawler or other external source may gather include, broadly, a consumer's PII. It is important to note that a web-crawler or other external source may only gather compromised PII (e.g., stolen PII), or PII that is suspected of compromise or associated with a factor suggesting compromise (e.g., public availability of the PII via the internet).

Transaction data database 112 may comprise any hardware and/or software configured or configurable to hold and/or process the internal and/or external customer data that a company, such as a transaction account issuer (e.g., American Express) maintains for its customers. Transaction data database 112 may contain one or more business rules and/or transaction fraud models, or the data comprising transaction data database 112 may be used to generate one or more business rules and/or transaction fraud models. Thus, the data comprising database 112 may be used or leveraged to predict transaction fraud on a customer (via a transaction fraud model). A business rule may comprise data that may tend to contradict the veracity of an identity theft score (described below). A business rule may also comprise data that may tend to confirm the veracity of an identity theft score.

An application models and business rules database 114 may comprise any hardware and/or software configured or configurable to hold and/or process the internal customer data that a company, such as a transaction account issuer (e.g., American Express) maintains for its customers. Application models and business rules database 114 may comprise one or more business rules and/or application fraud models, or the data comprising application models and business rules database 114 may be used to generate one or more business rules and/or application fraud models. Thus, the data comprising application models and business rules database 114 may be used or leveraged to predict application fraud (e.g., transaction account application fraud) on a customer (via an application fraud model).

A maintenance activity database 116 may comprise any hardware and/or software configured or configurable to hold and/or process the internal customer data that a company, such as a transaction account issuer (e.g., American Express) maintains for its customers. Maintenance activity database 116 may comprise one or more business rules and/or maintenance activity fraud models, or the data comprising maintenance activity database 116 may be used to generate one or more business rules and/or maintenance activity fraud models. Thus, the data comprising maintenance activity database 116 may be used or leveraged to predict maintenance activity fraud (e.g., transaction account takeover) on a customer (via a maintenance activity fraud model).

A customer verification activity database 118 may comprise any hardware and/or software configured or configurable to hold and/or process the internal customer data that a company, such as a transaction account issuer (e.g., American Express) maintains for its customers. Customer verification activity database 118 may comprise data related to a customer's verification of a charge to the customer's transaction account. Customer verification activity database 118 may further comprise data related to a customer's reporting fraudulent or suspected fraudulent activity on his transaction account.

With further regard to the data compromise database 110, the transaction data database 112, the application models and business rules database 114, the maintenance activity database 116, the customer verification activity database 118, the National Fraud Database 104, the Directory Assistance database 106, the other credit bureau databases 108, and the data comprise database 110, the data comprising each database 104-118 may be maintained in one or more physical databases. Thus, for example, databases 104-118 may comprise greater or fewer than eight databases. In other words, the data comprising each of the foregoing databases may be maintained individually or jointly.

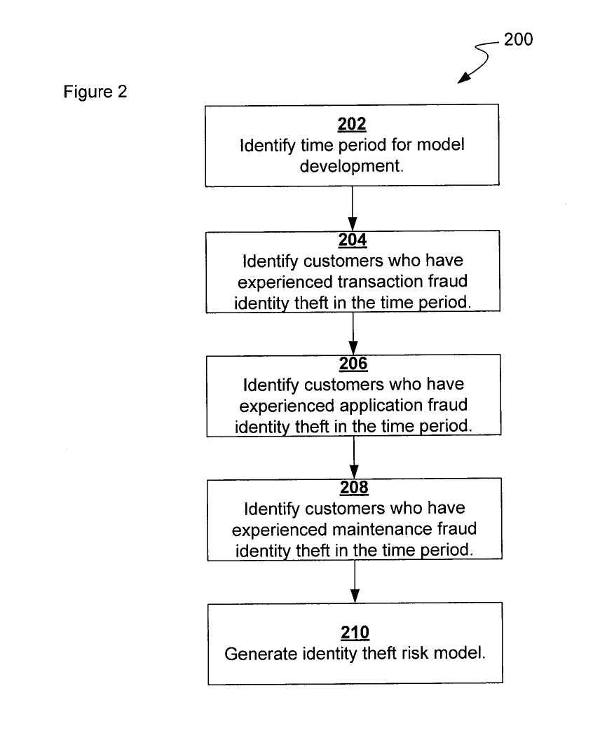

With reference to FIG. 2, an exemplary process 200 for generating an identity theft score is described. In an embodiment, an identity theft score may be determined based upon a regression equation or model (e.g., an identity theft risk model). Regression analysis is well known in the art and the methods and techniques for generating and evaluating regression models will not be discussed in detail herein. See, for example, NORMAN R. DRAPER, APPLIED REGRESSION ANALYSIS (1998); DAVID G. KLEINBAUM, APPLIED REGRESSION ANALYSIS AND MULTIVARIABLE METHODS (2007), the contents of which are hereby incorporated by reference.

An identity theft score may represent the probability or likelihood that a consumer or customer receiving a score (i.e., a “scoree”) will experience identity theft during a time period (e.g., an upcoming or future time period or a past or historical time period). For example, an identity theft score may indicate that a scoree is likely to experience identity theft during an upcoming or future time period—e.g., during the next several weeks or months. Similarly, an identity theft score may indicate that a scoree is unlikely, or moderately likely, to experience identity theft during an upcoming or future time period. In an embodiment, an identity theft score may indicate that a scoree's likelihood of experiencing identity theft during an upcoming or future time period is at least one of: lower risk, moderate risk, and higher risk. A score of higher risk may indicate a higher likelihood of experiencing identity theft during the time period and a score of lower risk, on the opposite end of the spectrum, may indicate a lower likelihood that the scoree will experience identity theft during the time period.

In an embodiment, an identity theft score may be generated by an identity theft risk model. As described above, the identity theft risk model may comprise a regression model. An identity theft risk model may be based upon a variety of data. For example, an identity theft risk model may be based upon any of the data comprising databases 104-118. Further, in an embodiment, an identity theft risk model may be based upon data associated with a time period (step 202). For example, an identity theft risk model may be based upon data occurring, collected, and/or measured one or more days, weeks, or months prior to a date upon which an identity theft score is calculated.

With further regard to the data upon which an identity theft risk model may be based, in an embodiment, an identity theft risk model may be based upon one or more of transaction fraud data, application fraud data, and maintenance fraud data. Transaction fraud data may comprise data associated with one or more consumers whose transaction accounts have been fraudulently utilized. For instance, a consumer whose transaction account has been used to make a payment for an item purchased by an individual to whom the transaction account does not belong or with whom the transaction account is not associated may be a victim of transaction fraud. In other words, transaction fraud may comprise a transaction by a thief who steals a consumer's transaction account number or accesses the transaction account without permission (e.g., in order to make a purchase).

In like manner, application fraud data may comprise data associated with one or more consumers whose personal identifying information (e.g., name, address, social security number, phone number, etc.) has been used by an individual who is not the consumer (e.g., to apply for a transaction account in the consumer's name). Maintenance fraud data may comprise data associated with one or more consumers whose transaction accounts have been fraudulently accessed in order to change personal identifying information (e.g., name, address, social security number, phone number, etc) associated with the transaction account. In other words, maintenance fraud data may comprise data associated with consumers whose transaction accounts have been “taken over” by one or more individuals. An identity theft risk model may be further based upon data associated with consumers whose identities have not been stolen within a time period.

In an embodiment, identity theft score system 100 may receive or identify consumers who have experienced transaction fraud during a time period (step 204). System 100 may further receive or identify consumers who have experienced application fraud during a time period (step 206) and/or consumers who have experienced maintenance fraud during a time period (step 208). In an embodiment, system 100 may further receive or identify a random sample of consumers who have not experienced identity theft during a time period (step 210).

System 100 may generate one or more identity theft risk models based upon the data received at steps 204-210 (step 212). That is, system 100 may perform a regression analysis based upon the data associated with the consumers identified at steps 204-210 (step 212). Further, a variety of independent (and/or dependent) variables may be used in the construction of an identity theft risk model. Exemplary variables may include maintenance activity (e.g., maintenance events such as password and/or username changes, changes of address, etc.), purchasing activity (e.g., monetary amount, quantity of items, etc.), transaction account application activity, reports of fraud or potential fraud reported by a credit reporting agency, a number of credit inquiries by creditors/transaction account issuers/lenders, a number of lost and/or stolen trade lines reported by a credit bureau, and the like. Thus, an identity theft risk model may be based upon a variety of variables; and coefficients associated with one or more variables may be determined or calculated based upon the data received at steps 204-210 (see materials incorporated herein by reference and related to regression analysis).

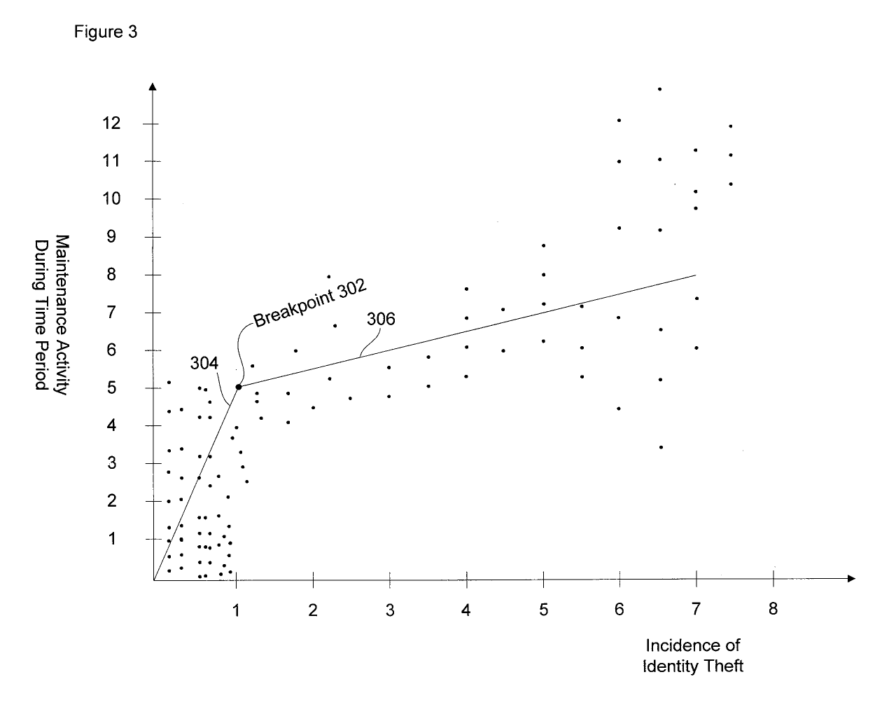

An identity theft risk model may comprise a variety of regression models. For instance, an identity theft risk model may comprise a linear regression model (single or multivariable), a nonlinear regression model (single or multivariable), a piecewise or segmented regression model, and the like. An identity theft risk model may further comprise a plurality of regression models or regression model equations; and these may comprise one or more of the foregoing example regression model types and/or any combination thereof. In an embodiment, the data used to generate an identity theft risk model may lend itself to a piecewise or segmented model. For instance, and with reference to FIG. 3, where an independent variable comprises maintenance activity, the data may suggest or show that maintenance activity by a consumer of less than five maintenance updates during a time period (e.g., name changes, password changes, address changes, etc.) is associated with a relative low incidence of identity theft. Five maintenance updates, in the example of FIG. 3, may therefore comprise a “breakpoint” 302, after which point the incidence of identity theft increases or may increase at a much greater rate.

Data used to generate the identity theft risk model may therefore be segmented into pieces during construction/generation of an identity theft fraud model (step 212). Further, each piece or segment may be given a label or otherwise associated with a risk of identity theft. In the example of FIG. 3, a first segment 304 may be associated with a low risk of identity theft. Likewise, a second segment 306 may be associated with a high (or higher) risk of identity theft. As described above, an identity theft risk model may comprise a large number of variables; and it may be based upon a large amount of data. Thus, a plurality of segments may be identified for each independent variable, and/or a segment may be determined based upon a combination/plurality of variables. In an embodiment, one or more independent variables may be associated with segments as follows: lower risk, moderate risk, and higher risk, where a score of higher risk indicates a high likelihood that a scoree will experience identity theft during the time period and a score of lower risk, on the opposite end of the spectrum, indicates a low likelihood that the scoree will experience identity theft during the time period. In the example of FIG. 3, where only two segments exist, segment 304 might receive a label of “lower risk,” while segment 306 might receive a label of “higher risk.”

In an embodiment, the independent variables relied upon for data segregation may be translated from a transaction level to a consumer or customer level. For example, certain consumers/customers may have greater than a single transaction account (e.g., credit card, bank account, etc) with which purchases are made. At a transaction level, a plurality of transactions may occur in association with a plurality of transaction accounts. Each of these transactions may be associated with a field, statistic, and/or other data, e.g., “Field A.” In order to translate all of a customer's data (i.e., Fields A) from a transaction level to a customer level, system 100 (or another associated system) may summarize or aggregate a customer's Fields A from all of the customer's transactions on all of the customer's transaction accounts. Thus, in short, data may be translated from a transaction level to a customer level by summarizing/aggregating data associated with the same or similar transactions occurring in association with different transaction accounts.

Further, in an embodiment, an identity theft risk model may be validated. An identity theft risk model may be validated based upon data associated with a time period that is different than the time period for which data was collected in order to generate the model. For example, in an embodiment, data associated with a time period (a “different time period”) that is different than the time period modeled by the model may be input to the model. A different time period may comprise a historical time period. If the model output (i.e., the set of identity theft scores) accurately reflects the incidence of identity theft during the different time period, the model is validated. For example, if the model predicts that a group of consumers/scorees were likely to experience identity theft during the different time period, the model may be validated provided that those consumers/scorees in fact actually experienced identity theft. If, on the other hand; the model predicts that a group of consumers/scorees were likely to experience identity theft during the different time period; and those consumers/scorees in fact did not experience identity theft, the model may be invalid.

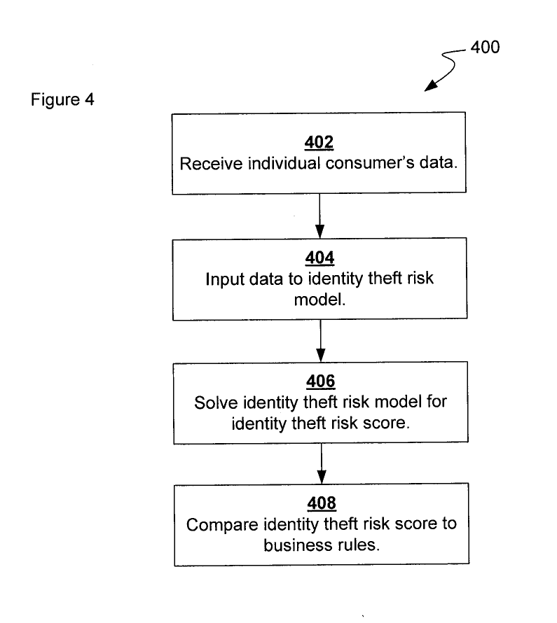

Referring to FIG. 4, a process 400 for generating an identity theft score is described. In an embodiment, data associated with an individual consumer may be received by system 100 (step 402). The data associated with an individual consumer may be substituted for one or more independent variables in the identity theft risk model (step 404). For instance (continuing with the simplified example described at FIG. 3), where the data associated with an individual consumer comprises maintenance activity (e.g., a number of maintenance events), this data may be input by system 100 to an identity theft risk model. The model may be solved for an identity theft score. (step 406). By way of example, and again with reference to the simplified example of FIG. 3, where a consumer has fewer than five maintenance events associated with his transaction account during a time period, system 100 may determine that the consumer has a lower risk of identity theft (which may be associated with an identity theft score of lower, etc). Similarly, where a consumer has greater than five maintenance events associated with his transaction account during a time period, system 100 may determine that the consumer has a higher risk of identity theft (which may be associated with an identity theft score of lower, moderate, higher, etc). Of course, system 100 may perform this process based upon a large number of independent variables and using a larger number of risk segments. The example of FIG. 3 is merely illustrative of a less complex process and is described here for clarity as well as the reader's benefit. For example, a large variety of variable substitution values may be supplied to system 100 for an individual consumer, including, purchasing activity (monetary amount, quantity of items, etc.), transaction account application activity, reports of fraud or potential fraud reported by a credit reporting agency, a number of credit inquiries by creditors/transaction account issuers/lenders, a number of lost and/or stolen trade lines reported by a credit bureau, and the like.

In an embodiment, an identity theft score may be compared to one or more business rules associated with a scoree (step 408). As described above, a business rule may comprise data that tends to contradict or confirm the veracity or accuracy of an identity theft score. Thus, for example, in an example where a scoree receives a positive (e.g., lower, etc.) identity theft score, but the scoree earlier received a fraud warning or that the scoree's transaction account was the subject of a fraud hold initiated by his transaction account issuer, the scoree's identity theft score may be adjusted towards a more negative score (e.g., moderate, higher, etc.) in order to reflect the earlier fraud warning or fraud hold. A scoree's identity theft score may also be adjusted towards a more positive score in response to one or more business rules that contradict the veracity or accuracy of the scoree's (more negative) score.

In another embodiment, a scoree's score may be adjusted towards a more positive or negative score based upon a business rule (or rules) that tends to confirm the veracity or accuracy of the scoree's identity theft score. For example, a scoree may receive a negative identity theft score; and a business rule associated with the scoree may indicate that the scoree recently received a fraud warning or that the scoree's transaction account was the subject of a fraud hold initiated by the scoree's transaction account issuer, the scoree's identity theft score may be adjusted towards a more negative value (or the scoree's score may not be adjusted, e.g., where the scoree's score is already a lowest score). A scoree's score may also be adjusted towards a more positive score in response to one or more business rules that confirm the veracity or accuracy of the scoree's (already positive) score. Thus, in general, a business rule or a set of business rules may be used to confirm and/or contradict the veracity and/or accuracy of an identity theft score. An identity theft score may be adjusted towards a more positive value, towards a more negative value, and/or not adjusted in response to the one or more business rules.

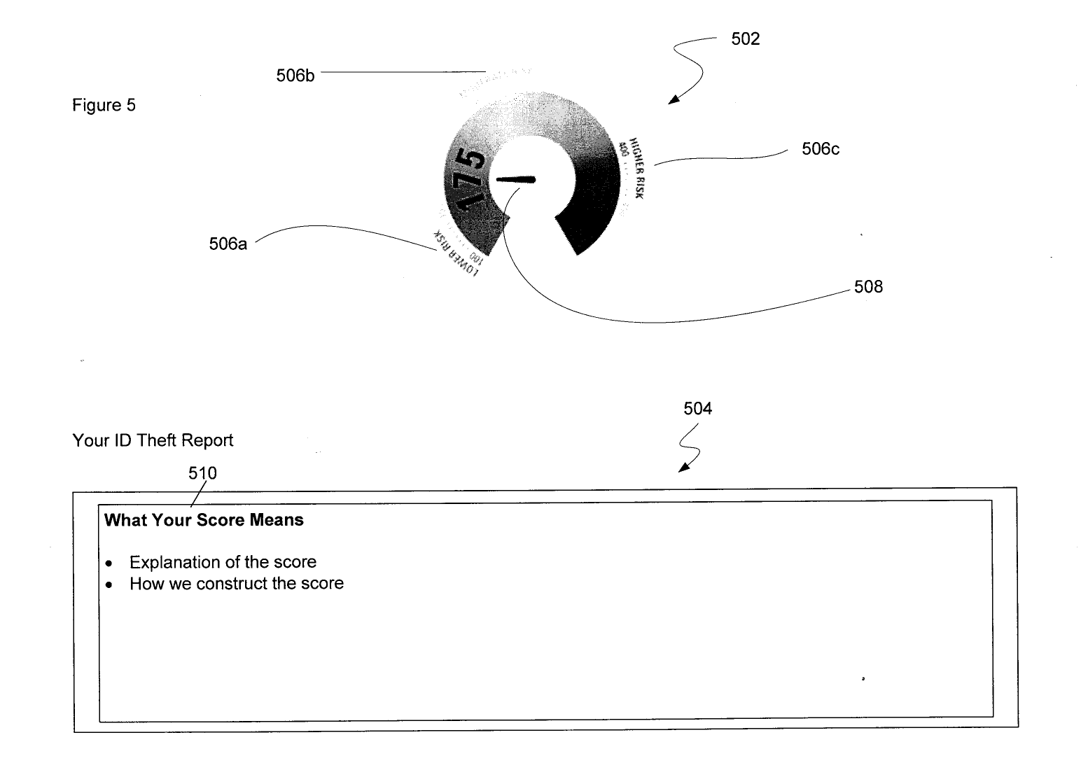

Referring to FIG. 5, an exemplary identity theft score assessment 500 is displayed. In an embodiment, an identity theft score assessment 500 may be displayed for a consumer by way of the consumer's web-client 102. An identity theft score assessment 500 may provide a consumer's identity theft score by way of an identity theft score meter 502 and/or an identity theft report 504.

The identity theft score meter 502 may comprise a plurality of meter indicia 506a-506c; and each of the indicia 506a-506c may be associated with an identity theft score segment and/or score. For example, in the depicted embodiment, the indicia 506a is associated with an identity theft score of “Lower Risk.” Likewise, indicia 506b is associated with a score of “Moderate Risk,” and indicia 506c is associated with a score of “Higher Risk.” As described above, a consumer who receives an identity theft score of “Higher Risk” may be at considerable risk of experiencing identity theft. Conversely, a consumer who receives an identity theft score of “Lower Risk” may be at very little risk of experiencing identity theft. Although three indicia or segments of identity theft score are contemplated above, a larger or smaller number of identity theft score indicia/segments are within the scope of the present disclosure. With continuing regard to FIG. 5, a needle or indicator 508 may be disposed or displayed in association with each of the indicia segments 506a-506c. The needle 508 may point to the indicia 506a-506c most representative of a consumer's identity theft score.

In an embodiment, an identity theft report 504 may inform a consumer as to the meaning and importance of his identity theft score. Thus, in an embodiment, an identity theft report 504 may explain what an identity theft score means 510. For instance, identity theft report 504 may provide information including positive and negative factors affecting a consumer's score (e.g., referring to the example of FIG. 3, a high number of maintenance events) and/or an explanation of how the score was calculated (e.g., based upon a regression analysis). Further, in an embodiment, identity theft report 504 may explain how a consumer's transaction account issuer (e.g., American Express) is protecting the consumer. Report 504 may further permit a consumer to communicate with a representative—e.g., a consumer may call an identity theft hotline, enter an identity theft chat room, and/or email an identity theft professional. Report 504 may also offer some reassurance to the consumer with respect to the protection his transaction account issuer offers or may offer. Further still, in an embodiment, identity theft report 504 may show a consumer additional steps that he may take to protect himself against identity theft. To this end, identity theft report 504 may offer the consumer information relating to one or more identity theft resources or a paid identity theft protection service. For example, report 504 may offer the consumer an “up-sell” or “cross-sell” to a paid identity theft protection service. A paid identity theft protection service may offer for a monthly premium a host of interrelated identity monitoring services. For instance, such a service may include an additional identity theft score, illegal website surveillance, offline database scans, lost wallet protection, and/or identity theft insurance.

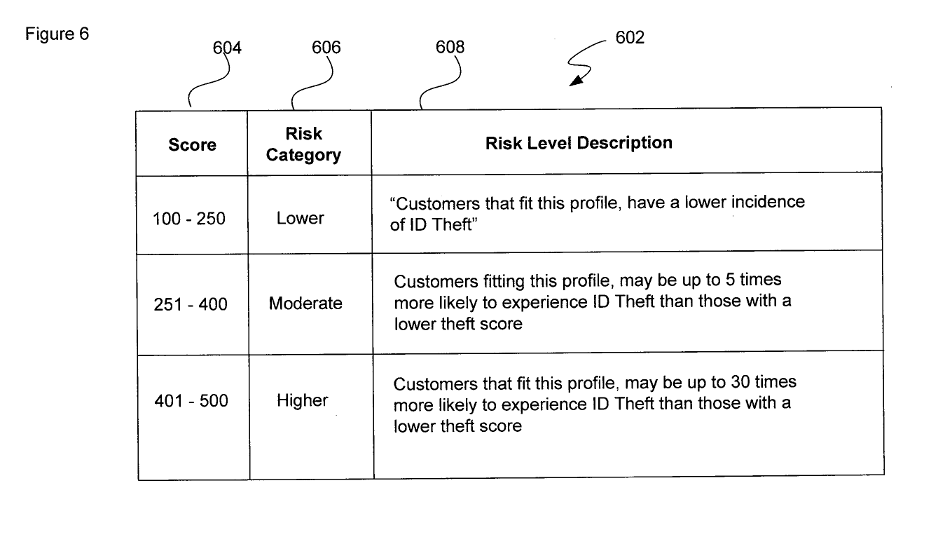

With reference to FIG. 6, a consumer may be presented with a table resembling table 602. Table 602 may present a range of identity theft scores 604 in a column, followed by a risk category 606, and/or a risk level description 608. A risk category 606 may be synonymous with, narrower, or broader than meter indicia 506a-506c. That is, a risk category 606 may correspond to the meter indicia 506a-506c, described above, or a risk category 606 may correspond to a broader or narrower category of risk than the meter indicia 506a-506c. Thus, a probability of identity theft may map to a risk category 606, however it may be defined. A risk level description 608 may provide information to a consumer about the consumer's risk category 606. For example, a consumer who falls into a risk category 606 of “Lower” may be associated with a risk level description indicating that “customers who fit this profile have a lower incidence of identity theft.” Likewise, a consumer who falls into a risk category 606 of “Higher” may be associated with a risk level description indicating that “customers who fit this profile may be up to 30 times more likely to experience identity theft than those with a lower identity theft score.”

In an embodiment, a consumer may be required to enroll or log in to receive an identity theft score. That is, in an embodiment, a consumer who is a customer of a transaction account issuer (i.e., a consumer who holds a transaction account issued by the transaction account issuer) may be required to log in, via his web-client 102, to his transaction account. Where a consumer is not a customer of a transaction account issuer, he may be required to apply for a transaction account prior to receiving an identity theft score. In an embodiment, a consumer may receive an identity theft score irrespective of his status as a customer (or lack thereof). That is, in an embodiment, any person may receive an identity theft score. In an embodiment, a consumer, whether his is a customer or not, may be required to consent to generation, by system 100, of an identity theft score.

In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in certain embodiments.

In various embodiments, the methods described herein are implemented using the various particular machines described herein. The methods described herein may be implemented using the particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, 95/98/2000, XP, Vista, OS2, UNIX, Linux, Solaris, MacOS, etc.) as well as various conventional support software and drivers typically associated with computers. A user may include any individual, business, entity, government organization, software and/or hardware that interact with a system.

In an embodiment, various components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security. A firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQTM (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term “end user”, “consumer”, “customer”, “cardmember”, “business” or “merchant” may be used interchangeably with each other, and each shall mean any person, entity, machine, hardware, software or business. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein.

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the inventions have been described as a method in certain embodiments, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method comprising:
identifying, by a computer-based system for generating an identity theft score, a plurality of consumers who have experienced identity theft during a historical time period;
generating, by the computer-based system, an identity theft risk model based upon the plurality of consumers who have experienced identity theft, wherein the identity theft risk model comprises a regression model;
generating, by the computer-based system, an identity theft score for an individual consumer based upon the identity theft risk model and data associated with the individual consumer, wherein the identity theft score represents a probability that the individual consumer will experience identity theft during a future time period.

2. The method of claim 1, wherein the identifying further comprises at least one of:
identifying, by the computer-based system, a plurality of consumers who have experienced transaction fraud during the historical time period;
identifying, by the computer-based system, a plurality of consumers who have experienced application fraud during the historical time period;
identifying, by the computer-based system, a plurality of consumers who have experienced maintenance fraud during the historical time period.

3. The method of claim 1, further comprising generating, by the computer-based system, the identity theft risk model based upon a plurality of consumers who have not experienced identity theft during the historical time period.

4. The method of claim 1, wherein the regression model comprises a segmented regression model.

5. The method of claim 4, wherein each of a plurality of segments comprising the segmented regression model is respectively associated with a different identity theft score.

6. The method of claim 1, further comprising adjusting the identity theft score based upon a business rule.

7. The method of claim 6, wherein a business rule comprises data that at least one of:
contradicts and confirms the accuracy of the identity theft score.

8. The method of claim 1, wherein the identifying is based upon both of internal data and external data.

9. The method of claim 1, further comprising generating, by the computer-based system, a web-page associated with the identity theft score.

10. The method of claim 1, further comprising generating, by the computer-based system, an identity theft score meter comprising at least one of a lower indicia, a moderate indicia, and a higher indicia.

11. The method of claim 1, further comprising generating, by the computer-based system, an identity theft score report that describes the meaning of the identity theft score.

12. A system comprising:
a tangible, non-transitory memory communicating with a processor for generating an identity theft score,
the tangible, non-transitory memory having instructions stored thereon that, in response to execution by the processor, cause the processor to perform operations comprising:
identifying, by the processor, a plurality of consumers who have experienced identity theft during a historical time period;
generating, by the processor, an identity theft risk model based upon the plurality of consumers who have experienced identity theft, wherein the identity theft risk model comprises a regression model;
generating, by the processor, an identity theft score for an individual consumer based upon the identity theft risk model and data associated with the individual consumer, wherein the identity theft score represents a probability that the individual consumer will experience identity theft during a future time period.

13. The system of claim 12, wherein the identifying further comprises at least one of:
identifying, by the processor, a plurality of consumers who have experienced transaction fraud during the historical time period;
identifying, by the processor, a plurality of consumers who have experienced application fraud during the historical time period;
identifying, by the processor, a plurality of consumers who have experienced maintenance fraud during the historical time period.

14. The system of claim 12, wherein the processor further performs operations comprising generating, by the processor, the identity theft risk model based upon and a plurality of consumers who have not experienced identity theft during the historical time period.

15. The system of claim 12, wherein the regression model comprises a segmented regression model.

16. The system of claim 15, wherein each of a plurality of segments comprising the segmented regression model is respectively associated with a different identity theft score.

17. The system of claim 12, wherein the processor further performs operations comprising adjusting, by the processor, the identity theft score based upon a business rule.

18. The system of claim 17, wherein a business rule comprises data that at least one of:
contradicts and confirms the accuracy of an identity theft score.

19. The system of claim 12, wherein the identifying is based upon both of internal data and external data.

18. An article of manufacture including a non-transitory, tangible computer readable medium having instructions stored thereon that, in response to execution by a computer-based system for generating an identity theft score, cause the computer-based system to perform operations comprising:
identifying, by the computer-based system, a plurality of consumers who have experienced identity theft during a historical time period;
generating, by the computer-based system, an identity theft risk model based upon the plurality of consumers who have experienced identity theft, wherein the identity theft risk model comprises a regression model;
generating, by the computer-based system, an identity theft score for an individual consumer based upon the identity theft risk model and data associated with the individual consumer, wherein the identity theft score represents a probability that the individual consumer will experience identity theft during a future time period.
